(19) United States
(12) Patent Application Publication
(10) Pub. No.: US 2002/0120394 A1
(43) Pub. Date: Aug. 29, 2002

(54) Fleet position monitoring system

(76) Inventor: Mark W. Rayne, Cambridgeshire (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 09/876,893

(22) Filed: Jun. 7, 2001

Related U.S. Application Data
(63) Continuation of application No. PCT/GB99/04123, filed on Dec. 7, 1999.

(30) Foreign Application Priority Data
Dec. 7, 1998 (GB) 9826873.3

(51) Int. Cl. G01C 21/00

(52) U.S. Cl. 701/207; 340/988

(57) ABSTRACT

A system which allows a central control unit to track automatically the positions of a fleet of mobile units. Each mobile unit carries a position updating apparatus which includes means to determine its position, and processing means in the form of computing equipment in communication with the position determining means. The processing means in turn controls a transmitting means, such as a radio transmitter of the private mobile radio system that the mobile unit uses for communication, for transmitting information to the central control. The position determining means and processing means are arranged to send the latest position of the mobile unit to the central control at intervals. The processing means stores a number of rules for determining the interval between the transmission of position update messages to the central control. These rules are based upon the direction of travel of the mobile unit and other factors, such as its location.

This invention relates to a method of and apparatus for monitoring the positions of one or more mobile units, such as vehicles or individual people.

There is often a need to be able to monitor the positions of a number of vehicles e.g. a fleet of buses, taxis or delivery vans, for example in order to be able to coordinate their movements and ensure that they are in the right place at the right time. Typically this is achieved by the individual vehicles transmitting their current positions to a central control unit at which the vehicle's positions are monitored.

In known such systems, the individual vehicles typically update their positions to the central control at predetermined time or distance intervals, e.g. every 10 seconds or after every 500 m travelled. If every vehicle in the fleet updates its position at frequent intervals, it is possible to know the position of every vehicle to a high degree of accuracy. However, requiring every vehicle to update its position at frequent intervals requires a relatively high data transmission capacity (for example radio channel capacity) particularly if large numbers of vehicles are involved. In practice such capacity may not be available. The transmission capacity requirements can be reduced by increasing the intervals between positional updates, but this incurs a commensurate loss in the accuracy of the position information held at the central control.

According to a first aspect of the present invention, there is provided a method of monitoring the position of a mobile unit, comprising the steps of said mobile unit determining its position, determining its direction of travel, and transmitting information relating to its position to a central unit at intervals, wherein the interval between successive position transmissions is selected in accordance with the direction of travel of the mobile unit.

According to a second aspect of the present invention, there is provided a position updating apparatus, comprising:

means for determining line position of the apparatus;

means for determining the direction of travel of the apparatus;

means for transmitting information relating to the position of the apparatus to a central unit at selected intervals; and

means for selecting the interval between successive position information transmissions on the basis of the direction of travel of the mobile unit.

In these aspects of the present invention a mobile unit, such as a vehicle, transmits information relating to its current position to a central unit automatically at intervals selected on the basis of its direction of travel. By varying the interval between position updates for individual mobile units or apparatus depending on their direction of travel, the transmission capacity available to be used by a fleet of mobile units operating in accordance with the method of the present invention or including the position updating apparatus of the present invention can be used more efficiently and the transmission capacity use can be tailored more precisely to the actual requirements of an operator.

For example, it may be that a fleet operator only needs to know the position of a mobile unit with a high degree of accuracy when travelling in particular directions, but not otherwise. BY selecting the update interval in accordance with the direction of travel, it can be arranged such that updates only occur frequently (and thus transmission capacity used heavily) for a given mobile unit when the unit's direction of travel dictates that its position needs to be known to a high degree of accuracy. At other times when its position does not need to be known as accurately, the unit can send position updates less frequently, thereby using less transmission capacity and freeing capacity for use by other mobile units. Hence the overall transmission capacity required can be reduced, while still providing high positional accuracy for mobile units when required.

This contrasts with arrangements in which updates always occur at the same fixed intervals, since in those arrangements the updating frequency (and thus data transmission capacity requirement) will necessarily be determined by the maximum positional accuracy that could be required, even though such accuracy may not be required all the time. This may mean that the transmission capacity allocated to position updates in such arrangements is greater than it needs in practice to be. By varying the update interval, this problem can be overcome.

The interval between position transmissions or updates can be selected as desired on the basis of the direction of travel of the mobile unit. For example, the interval selection could depend upon whether the mobile unit is travelling in a specific direction or set or range of directions, such as approaching or receding from a particular, e.g. predetermined, point, border or boundary, or travelling on a particular bearing or within a particular range of bearings. The interval selection can be based on the instantaneous direction of travel of the mobile unit, but where appropriate and possible, preferably the average direction of travel over a particular, preferably predetermined, time or distance period, is used.

The direction of travel of the mobile unit can be determined as desired, e.g. by comparing successive determined positions of the mobile unit. It is preferably done at appropriate regular intervals.

The interval between position updates may also be influenced by other factors in addition to the direction of travel. It could, for example, also be selected on the basis of whether one or more other predetermined conditions or events have been met or occurred. For example, the selection could be based additionally on the positional accuracy required by a monitoring operator, and/or the absolute position of the mobile unit, and/or the distance between the mobile unit and one or more particular or predetermined locations such as fixed way points, borders or boundaries.

The position update interval selection could additionally be based on time factors, such as the time of day/year, day of the week etc. For example, more accurate positions may be required in rush-hour, in summer time, or on week days.

Thus the position transmission selection is preferably made from a set of two or more predetermined position update intervals on the basis of one or more predetermined selection criteria or rules. For example, each predetermined position transmission interval could be associated with one or more conditions or events (e.g. travel in a particular direction or any of the other possible criteria discussed above) which when met causes that interval to be selected. The apparatus of the present invention preferably therefore includes a memory which stores a plurality of predetermined update intervals and one or more rules for determining the interval to be used, and means for selecting the update interval in accordance with those rules, perhaps in conjunction with data supplied from the position determining means and/or a clock (for example if the interval depends upon the time of day/year, etc.).

The rules could, for example, associate particular predetermined conditions, such as directions travelled, optionally relative to one or more predetermined locations and/or relative to the distance of the mobile unit from one or more predetermined locations with particular predetermined intervals. The apparatus could then compare its actual direction of travel with the directions in the rules which are stored in the memory, and use that comparison and the rules to determine the update interval.

The rules could also have specified time periods or areas of validity, with recourse to a default rule or an alternative rule outside of such times or areas, it desired.

The update interval could also be changed remotely e.g. by a signal sent from the central unit. This allows a fleet operator to control the update intervals for each of a fleet of mobile units in order to optimise use of the available transmission capacity. This mode of operation is of course distinct from one in which the central unit sends a specific, one-off, request for a position update, since it is the interval between successive position updates which is modified.

The update interval could also be changed by a signal from a roadside transmitter or the like, for example when the mobile unit or apparatus approaches or passes the location of the transmitter.

The position transmission interval selection arrangement is preferably such that a particular selected position update interval is used and prevails (i.e. such that the mobile unit transmits position updates regularly at the selected update interval) until such time as a new interval is triggered by, for example, the mobile unit travelling in a direction for which a different update interval is specified. The new interval would then prevail until another condition or event to change the interval occurred.

In a particularly preferred embodiment, a default update interval is defined for when no other criteria apply, but when the mobile unit or apparatus moves in a given direction, preferably within a given distance from a fixed point, a new interval is selected.

An example of this would be when a bus is travelling towards a way point such as a bus stop. Its position would not be needed very accurately away from the stop and so the default interval could apply, but its position would ideally be known with increased accuracy as it approached the stop. This would be achieved by specifying rules for determining the update interval which override the default interval when the bus travels in a direction towards the stop (and preferably also as it nears the stop). As soon as the bus has arrived and then departed and is travelling away from the stop (and preferably also has moved sufficiently far away from the stop that it can, for example, be removed from an information or ‘arrivals’ display), the bus's position would not be needed so accurately, and so the update interval could revert to the default interval.

It is believed that an arrangement in which the interval for regular position updates is selected on the basis of the direction of travel or distance of a mobile unit relative to a plurality of predetermined locations or way points is in itself novel and advantageous.

Thus according to a third aspect of the present invention, there is provided a method of monitoring the position of a mobile unit, comprising:

defining two or more predetermined locations;

defining a set of two or more predetermined position update intervals, each interval in the set being associated with one or more predetermined selection criteria each relating to the distance of the mobile unit from, or the direction of travel of the mobile unit relative to, one of the predetermined locations;

selecting an update interval from the set of predetermined update intervals on the basis of the predetermined selection criteria;

determining the position of the mobile unit; and

providing to a central unit updates of the mobile unit's position at the selected predetermined interval.

According to a fourth aspect of the present invention, there is provided an apparatus for monitoring the position or a mobile unit, comprising:

means for determining the position of the mobile unit;

means for storing the positions of two or more predetermined locations; means for storing a set of two or more predetermined position update intervals, each interval in the set being associated with one or more predetermined selection criteria each relating to the distance of the mobile unit from, or the direction of travel of the mobile unit relative to, one of the predetermined locations; and

means for providing to a central unit updates of the mobile unit's position at intervals selected from the set of predetermined update intervals on the basis of the predetermined selection criteria.

In a preferred embodiment of the invention, the position update interval is set to a higher value (or even a very high value or even disabled (set to infinity)) whilst the mobile unit or apparatus moves along a certain route (which can, for example, be defined by a predetermined line), but set at a smaller interval if the mobile unit or apparatus moves off or departs from that route. Such an arrangement would be particularly useful where the mobile unit was a security van which would have a well defined route but would need to be closely tracked if it were to be stolen and thus stray from that route. Departure from the route could be defined as, for example, the mobile unit moving a predetermined distance away from the route (e.g. moving a predetermined distance away from a predetermined line defining the route), the mobile unit travelling in one or more particular directions relative to the route (e.g. the wrong direction along the route (e.g. the wrong way along a predetermined line defining the route)), or the mobile unit not being within a given portion of the route at a given time or during a given time window, or a combination of any or all of these factors.

Thus in a preferred embodiment, the arrangement comprises the mobile unit providing information regarding its position to a central unit at a predetermined regular interval when it is determined that the mobile unit has moved a predetermined distance away from a predetermined line.

Indeed this type of arrangement is believed novel and advantageous in its own right and not just in the context of a method or apparatus in accordance with the aspects of the invention described above. Thus, when viewed from a fifth aspect, the present invention provides a method of selectively monitoring the position of a mobile unit, comprising:

the mobile unit determining its position, comparing the position determined with the position of a predetermined line, and when the determined position first exceeds a predetermined distance from said predetermined line, transmitting information relating to that event to a central unit.

A sixth aspect of the invention provides an apparatus for selectively monitoring the position of a mobile unit, comprising:

means for determining the position of the mobile unit;

means for comparing the position determined with the position of a predetermined line; and

means for when the determined position first exceeds a predetermined distance from said predetermined line, transmitting information relating to that event to a central unit.

Thus it will be seen that in accordance with these aspects of the invention, a central unit can receive automatically an indication when a mobile unit moves too far away from or deviates from a predetermined line defining a route that the mobile unit is intended to travel. This is beneficial where information is only really required if the mobile unit when on its journey strays from its intended route—e.g. a security van which has been stolen or hijacked. Given the relative infrequence of such events, this would allow a large number of vehicles to be associated with a single central unit whilst maintaining the ability for any of them to be monitored closely if the need should arise, i.e. if any of them should stray from their designated route.

The information signal relating to the route deviation event may simply comprise an alert which warns the central unit that something is amiss, but preferably also comprises information relating to the position of the mobile unit, and also most preferably information identifying the mobile unit.

The information relating to the event (i.e. the route deviation) may just be sent once when the mobile unit first transmits information after finding itself to have strayed from its route. In a particularly preferred embodiment, however, once an information transmission is triggered, information relating to the position of the mobile unit is transmitted automatically thereafter at regular intervals, e.g. such that when it is determined that the mobile unit is more than the predetermined distance from the predetermined line, the mobile unit starts to transmit position updates to the central unit at predetermined intervals, as this allows the mobile unit to be tracked. These intervals may be regular temporal or spatial intervals. In preferred embodiments of these aspects of the invention where it is unlikely that more than one mobile unit will need to send position updates at any given time, the intervals may be set so as to utilise substantially all of the available bandwidth which could be very beneficial for example in helping to catch criminals who have stolen a security van.

The information relating to the position of the mobile unit could also be transmitted upon request from the central unit.

The mobile unit may transmit position updates only while it remains more than a predetermined distance from the predetermined line. Preferably however, the mobile unit transmits regular position updates substantially continually once it has been initially triggered until it has been positively stopped from doing so. This allows the mobile unit to be tracked even if it should happen to cross or resume its originally intended route.

The predetermined distance from the predetermined line to trigger automatically a position update can be selected as desired and may be set at any suitable value. It may vary as a function of the distance along the line. Preferably however this distance remains constant throughout the length of a given predetermined line, and most preferably is independent of the direction of the mobile unit from the line. In either case, the distance considered when deciding whether to trigger an event (e.g. position) update is preferably the minimum distance between the determined position of the mobile unit and the line (i.e. the distance to the nearest point on the line; the distance along the perpendicular from the line to the mobile unit's position).

In a particularly preferred embodiment the predetermined line is straight. Where this is the case, a more convoluted route may be defined by a series of predetermined straight lines, each corresponding to respective portions of the route. In a particularly preferred such embodiment, each predetermined line is defined as the line joining a respective pair of predetermined fixed points on the route. The mobile unit or apparatus can then determine or comprise means to determine which two fixed points it is closest to, to thereby select the line with which to make its distance comparison.

This arrangement is such that where a route is made up of successive straight lines joining successive fixed points, the route is effectively divided up into a number of imaginary sections or ‘corridors’. The length of each corridor is the separation of the two fixed points and the width is the maximum distance the mobile unit may be from the line before a transmission is triggered. In the preferred case therefore where the predetermined distance is constant along the length of the line, the corridor will be substantially rectangular

It is believed that monitoring whether a mobile units leaves a predetermined corridor joining two predetermined points is advantageous in its own right. Thus, according to a further aspect of the present invention, there is provided a method of monitoring the position of a mobile unit comprising:

defining a corridor joining two predetermined points along which the mobile unit is intended to travel;

the mobile unit determining automatically whether it has left the defined corridor, and providing automatically information relating to that event to a central unit when the mobile unit determines that it has left the defined corridor.

According to a further aspect of the present invention, there is provided an apparatus for monitoring the position of a mobile unit, comprising:

means for storing the definition of a predetermined corridor joining two predetermined points along which the mobile unit is intended to travel;

means for determining whether the mobile unit has left the defined corridor, and providing information relating to that event to a central unit when it is determined that the mobile unit has left the defined corridor.

In a particularly preferred embodiment a predetermined distance (e.g. radius) is also defined around the end points of the or each predetermined line (i.e. the fixed points in the route between which the lines are defined) which must be exceeded before position transmissions are triggered. This provides a circle of ‘allowed’ region for the mobile unit additionally around each line end point. This avoids the potential problem of an excessive sensitivity to small deviations of the mobile unit from the intended route in the vicinity of the line end points. The radius of the circle may be different for each line end point or may be the same for all line end points. In a preferred embodiment a circle having a radius substantially equal to the predetermined distance for the or one of the lines terminating at the line end point is used. Where two or more lines end at the same point, most preferably the shorter predetermined distance is chosen.

Where a predetermined straight line is used, the predetermined distance which the mobile unit must stray from the line to trigger an event transmission is preferably set to be equal to or marginally greater (e.g. a predetermined amount greater) than the maximum distance of any point on the actual, physical intended route between the line end points, from the predetermined line. This feature ensures that a position transmission will only be triggered if the mobile unit moves from its intended route, however irregular the actual route is relative to the predetermined straight line. By setting the predetermined distance marginally greater than the maximum deviation of the route from the predetermined line, false alerts may be avoided which could result e.g. from the finite resolution of the position determining means, whilst ensuring that genuine deviations from the intended route rapidly trigger a position transmission.

In a preferred embodiment, transmission of information relating to the event occurring or position of the mobile unit to the central unit is also triggered when the mobile unit is not within a given portion, e.g. within a predetermined distance from one of the predetermined lines or fixed points, or within a particular corridor, of an intended route at a given, e.g. predetermined, time or during a particular e.g. predetermined, time window. Where the mobile unit is a vehicle such as a security vehicle this will mean that the vehicle can be closely monitored if it stops for too long or travels too fast along its route, as well as if it strays from the route. Each of these events could indicate suspicious circumstances. In practice, sufficient flexibility may need to be given to allow for variable traffic conditions.

In some embodiments the defined times for each respective portion of the route will depend on e.g. the time or day, day of the week or time of year since these could e.g. influence traffic conditions. The times for the respective portions may be ‘absolute’ times e.g. time of the day or ‘relative’, times e.g. calculated from when the mobile unit began its journey. In embodiments where the intended route is defined as a series of corridors, then times may be defined for each corridor—e.g. with entry and exit time windows or simply a window for the whole corridor.

An event or position transmission may also be triggered if the mobile unit is found to be going in the wrong direction relative to its intended route. This could be determined e.g. by determining whether portions of the route, such as the corridors described above, are entered in the correct order, and/or by monitoring the distance of the mobile unit from the ends of a line or corridor. For example, reverse travel along a line or corridor for more than a predetermined distance could trigger an event or position transmission.

The mobile unit may remain silent if its position does not exceed a predetermined distance from the predetermined line, Preferably however the mobile unit transmits or comprises means to transmit automatically signals to the central unit to indicate that it is operating correctly in these circumstances. This signal may include information relating to the position of the mobile unit, although this is not necessary and it may, for example, just contain information identifying the mobile unit.

In further preferred embodiments the mobile unit comprises means to store some or all of its positions determined after a given point e.g. the start of a journey even it these positions were not communicated to the central unit. In such embodiments the mobile unit may additionally transmit information relating to its previous positions, most preferably with the associated time. This would for example allow an operator at the central unit to determine if and where the mobile unit had been stopped prior to its route deviation.

Information relating to the predetermined line or lines fixed points, and associated predetermined distances are preferably stored within the mobile unit in suitable storage means. This information may be stored permanently or semi-permanently in the said storage means, but may preferably be modified whenever necessary. This may be done at the mobile unit e.g. manually by an operator at the mobile unit, or automatically e.g. at a designated stop. Preferably however the information is modified by means of a transmission from the central unit. Such transmissions are preferably suitably encrypted to allow the mobile unit to discriminate between genuine and fake instructions. This would prevent for example a malicious party altering the intended route of a mobile unit such as a security van to avoid the detection of its deviation from the original route. The same applies for updates entered manually which therefore preferably require a password, personal identification number (PIN) or the like. Similarly the transmission of information relating to position to the central unit is preferably encrypted to thwart potential eavesdroppers.

For all aspects of the invention, the position update intervals may be time intervals, but preferably are spatial intervals, i.e. such that an update is triggered when the mobile unit has travelled a particular e.g. predetermined distance, rather than after a particular time. This provides a system in which the positions of mobile units can be monitored to a desired spatial accuracy, but without the need continuously to interrogate every mobile unit at short time intervals. For example, in this arrangement position updates from slow moving mobile units (e.g. vehicles stuck in slow moving traffic) will be less frequent (thereby avoiding unnecessarily frequent position updates for such mobile units and reducing the transmission capacity used by such slow moving or stationary mobile units) while still allowing an operator to know the position of the unit with the desired spatial accuracy.

Where spatial update intervals are used, the cumulative distance travelled by the mobile unit may be used to determine the updates, but preferably it is the net displacement which is used—i.e. when the mobile unit's or apparatus' position has changed by a predetermined amount (e.g. it has travelled a particular radius from the position given in the last update). The latter system is preferred since it further helps to avoid unnecessary updates when the mobile unit or apparatus retraces its path, but remains within the specified spatial resolution. The distance travelled could be determined by the apparatus or mobile unit by any suitable means known in the art, such as by measuring the distance travelled cumulatively e.g. using sensors attached to the wheels of a vehicle, since the last position update to the central unit. It is preferably determined by determining by how much the position of the apparatus or mobile unit has changed, for example by comparing the latest determined position of the mobile unit or apparatus with the last position transmitted to the central unit.

The position updates can occur both at given spatial intervals, and at specified temporal intervals as well, if desired. For example, by additionally updating at specified temporal intervals, position updates can still be sent even when a mobile unit is stationary. such a system would be able to avoid interpreting a lack of movement which would otherwise have resulted in no updates, as an error in the system. In such an arrangement, the temporal update interval is preferably set to a relatively long time period to provide a default update interval but which does not consume transmission capacity excessively.

For all aspects of the invention, the position of the mobile unit or apparatus may be determined using any suitable means. For example, its position relative to one or a plurality of known fixed points, e.g. radio or microwave beacons, could be measured. Alternatively, a system that senses the distance and direction travelled from a known starting point (for example using a compass and sensors coupled to the wheels of a vehicle) could be used. This latter method could be combined with another, e.g. absolute, positioning system for calibration purposes. Preferably however, the absolute position of the apparatus or mobile unit is determined e.g. by the observation of satellites, using the Global Positioning System, or by reference to other known fixed points, as is known in the art. The Global Positioning System method is particularly advantageous in that it utilises pre-existing readily available position determining means.

The position determination can occur at intervals as desired, but preferably occurs recurrently and most preferably at regular, fixed frequency intervals and preferably at a rate sufficient to ensure that the mobile unit or apparatus will not move more than the minimum spatial resolution required by an operator between determinations. It can occur at the same time and rate as the position updates are transmitted to the central unit. However, where the position or event transmission updates occur at particular positional changes determined by comparison of the determined positions, the position determination should occur at a rate fast enough for the relevant distance travelled to trigger an update to be accurately monitored. This will therefore be at a faster rate than the position update transmissions.

Where the position or event transmission is determined by a comparison of the determined position with a previous determined position or a predetermined position or line, such comparison is preferably carried out at regular intervals (e.g. every time a new position is determined) and preferably at a rate fast enough for a transmission to be triggered soon after the relevant position change has occurred.

The information relating to position transmitted to the central unit by the mobile unit or apparatus may be transmitted in any convenient format e.g. Cartesian coordinates of latitude and longitude. Preferably the position information is transmitted in the form of polar coordinates. A single fixed point could be used as the polar origin, but in a particularly preferred embodiment plural polar origins corresponding to particular locations or way points are used. In this case the mobile unit or apparatus transmits its position in polar coordinates relative to the particular location, together with the identification of the location to which they relate. This may allow the use of channel capacity to be minimized.

Preferably, as well as transmitting position information, the mobile unit or apparatus also transmits to the central unit information relating to its velocity—i.e. its speed and direction, most preferably as part of the signal in which it transmits the information relating to its position. This allows an operator more reliably to determine a predicted path for the mobile unit or apparatus and is more useful in gauging its progress. It can also allow an operator to predict when the next update transmission will be received, such that the operator can request an update if one has not been received when it should have been.

The information relating to the position of the mobile unit can be transmitted via a radio link to the central unit. In such an arrangement the transmitting means would typically be a mobile phone or radio of the mobile radio communication system with which the mobile unit communicates with its fleet controller, and the position data would typically be transmitted over the mobile radio network to a central unit associated with the radio network.

Transmission of information relating to position to a central unit could also be by means of fixed links such as cables as opposed to radio transmission. Furthermore the central unit need not be physically remote from the apparatus. Thus the invention is also intended to extend to a system in which the information relating to position is stored within the apparatus without being broadcast—e.g. when the apparatus is used as a tachograph or a ‘black box’ type of journey recorder where the position information may not always or even usually be looked at or used.

Although the position of just one apparatus or mobile unit could be monitored, in preferred embodiments of the invention a fleet of mobile units is monitored, This could be a fleet of vehicles or alternatively a group of people (whether in vehicles or not). In such cases each mobile unit could have the same set of rules for determining the update intervals. However, this is by no means necessary and each mobile unit could have individual, different intervals and/or rules.

The information transmitted by one or more mobile units or apparatus may be used only passively to monitor their positions, e.g. by displaying the information to an operator. Additionally or alternatively the information could be used more actively to control or influence external events. For example the position of a bus could be transmitted to the controller for a set of traffic lights to enable the lights to be influenced in the bus's favour. The information could be sent from the mobile unit or relayed from the base station.

The method and apparatus of the invention may be implemented using pure hardware means such as discrete components or hard-wired logic gates. Alternatively, the invention may be implemented at least partially using software, e.g. computer programs. It will thus be seen that when viewed from a further aspect, the present invention provides computer software specifically adapted to carry out the methods hereinabove described when installed on data processing means.

Furthermore it will be appreciated that the means specified in the apparatus of the invention may similarly comprise computer software specifically adapted to carry out the methods hereinabove described when installed on data processing means.

The invention also extends to a carrier comprising such software which when used to operate a position updating apparatus comprising a digital computer, causes, in conjunction with said computer, said apparatus to carry out the steps of the method of the present invention. Such a carrier could be a physical storage medium such as a ROM chip, CD ROM or disk, or could be a signal such as an electronic signal over wires, an optical signal or a radio signal such as to a satellite or the like.

It will further be appreciated that not all steps of the invention need be carried out by computer software and thus from a further broad aspect the present invention provides computer software such software installed on a carrier for carrying out at least one of the steps of the methods set out hereinabove. Similarly, not all of the means specified in the apparatus of the invention need comprise computer software and thus in the general preferred case, it is at least one of such means which comprises computer software.

Certain preferred embodiments of the present invention will now be described, by way of example only, and with reference to the accompanying drawings, in which:

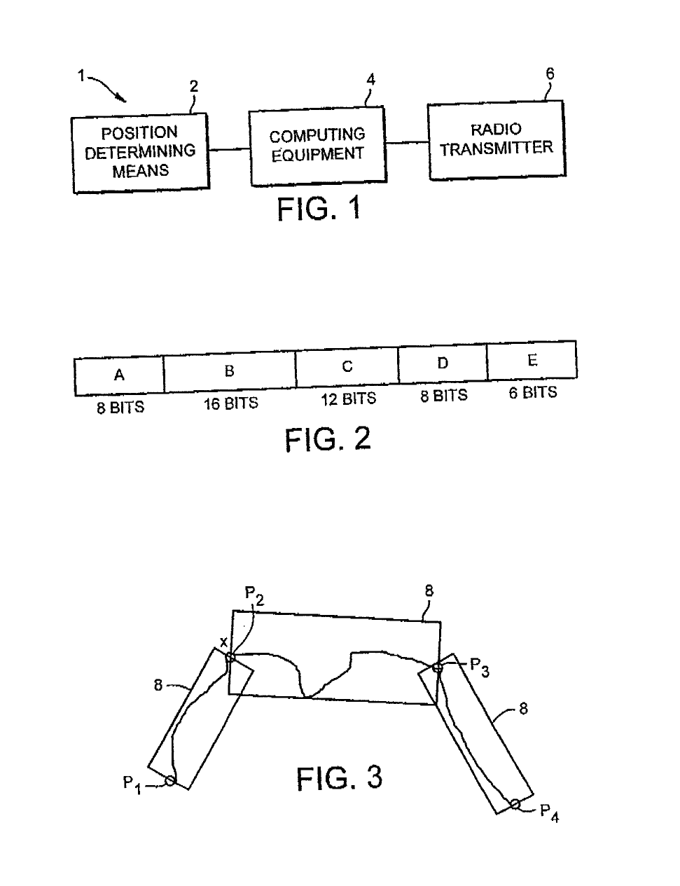

FIG. 1 is a block diagram of a position updating apparatus in accordance with the present invention;

FIG. 2 is a schematic diagram showing the format of a position data signal transmitted from the apparatus in FIG. 1; and

FIG. 3 is a diagram showing an intended route for a mobile unit.

The following described embodiment of the present invention is a system which allows a central control unit to track automatically the positions of a fleet of mobile units, which are buses in this example. As well as being able to use this information to manage the service provided by the buses, e.g. to ensure that sufficient buses are provided for an acceptable level of waiting, it allows the central unit to transmit to bus stops estimates of when the next few buses are to be expected, increasing passenger satisfaction and encouraging them to wait for a bus. The information could also be transmitted to traffic control systems as a bus approaches to allow them to favour the bus when controlling traffic.

Each bus carries a position updating apparatus in accordance with the present invention. Referring to FIG. 1, the position updating apparatus 1 includes means 2 to determine its position. The position determining means makes automatic regular determinations of the bus's location by measuring its distance from a number of satellites using the Global Positioning System, Alternatively a land-based system based on radio beacons, microwave beacons, bar codes read by a laser or the like could be used.

Processing means 4 in the form of computing equipment are in communication with the position determining means. The processing means 4 in turn controls a transmitting means 6, such as a radio transmitter of the private mobile radio system that the bus fleet uses for communication, for transmitting information to the central control.

The position determining means 2 is arranged to send the latest position of the mobile unit to the processing means 4 sufficiently regularly to ensure that the bus can never move more than the minimum spatial resolution required by the bus fleet operator between each position send. For example if the minimum spatial resolution specified by the fleet operator is 10 m and the maximum speed of the bus is 90 km/h, then the position determining means will send the latest position to the processing means 4 at least every 0.4 seconds. The position determining means 2 could instead contain sufficient processing power to calculate the distance travelled itself and use this to send the position to the processing means at a fixed spatial interval of at most 10 m.

As the bus moves, the processing means continuously calculates the distance the bus has travelled since it last transmitted a position update message to the central control. When this distance exceeds the current value for the update interval specified in the memory of the processing means, the processing means 4 induces the radio transmitter 6 to transmit automatically a new position update to the central control. The update interval corresponds to the accuracy with which the bus's position is to be known at that particular time and location.

The processing means 4 stores a number of rules for determining the interval between the transmission of position update messages to the central control. As discussed above, these rules are based upon the direction of travel of the bus and other factors, such as its location. A simple example of a table of rules, in which the update interval varies depending upon the location and direction of travel of a bus relative to a number of fixed way points (e.g. bus stops), is given in Table 1:

TABLE 1

| | | | | | | | Direction | | | | |
|---|---|---|---|---|---|---|---|---|---|---|---|
| | | | | | Distance | | | Bearing | | Position | |
| | Fixed Point | | Time | | Max | Min | | Min | Max | Accuracy | Frequency |
| Rule | ID | Location | From | To | (m) | (m) | | (°) | (°) | (m) | (s) |
| 1 | | | | | | | | | | 500 | 1000 |
| 2 | α | TQ1278234165 | | | 3000 | 0 | | | | 50 | |
| 3 | β | TQ1243124184 | | | 3000 | 50 | towards | 90 | 180 | 100 | |
| 4 | β | TQ1243124184 | | | 50 | 0 | | | | 10 | |
| 5 | γ | TQ1262624908 | 1500 | 1630 | 2000 | 0 | towards | | | 50 | |
| 6 | d | TL460621 | 0730 | 0930 | 2000 | 0 | towards | 280 | 80 | 50 | 120 |
| 7 | d | TL460621 | 0730 | 0930 | 1000 | 0 | away | 150 | 210 | 10 | 120 |
| 8 | d | TL460621 | 1630 | 1830 | 2000 | 0 | towards | 330 | 30 | 10 | 120 |

It should be noted that in the rules of table 1, the bearing ranges include all bearings going in a clockwise direction from the minimum to the maximum bearing defined for the rule (i.e. the rule is triggered if the vehicle is travelling within that range of bearings). Of course other definitions could be used if desired.

Here, rule 1 has no given position. This is a default rule for use when the bus is not in range of any of the defined fixed points. In a default condition, the bus is to signal its position whenever it has moved more than 500 m since it last sent a position update, or after 1000 s (whichever occurs first). However, according to rule 2 when it is within 3000 m of fixed point α, it should instead send a position update after every 50 m of travel. By rule 3, when the bus is approaching towards fixed point β, and is within 3000 and 50 meters on a bearing of between 90 and 180 degrees, the processing means 4 should instruct the transmitting means 6 to send a position update after each 100 m the bus travels. Once the bus is within 50 m of fixed point β at any bearing and in travelling in either direction, the position update is altered by rule 4 to once every 10 m. The instructions concerning fixed point γ (rule 5) are only activated between the times of 1500 and 1630. More complex examples are possible, e.g. in which the rules include the day of the week.

Rules 6, 7 and 8 provide a way of charting the progress of a vehicle through a junction or traffic congestion point (at the indicated location) in the morning and evening rush hours. Rule 6 covers vehicles approaching the junction from the North, West and East in the morning. Rule 7 is for vehicles travelling south away from the junction in the morning. Rule 8 is for vehicles approaching the junction from the south in the evening. There is no rule to deal with vehicles leaving the junction in the evening, as in this example it is considered that the junction is generally clear in those directions at that time.

A fleet operator or the central control unit operating automatically, could tune the reporting information and rules stored in the vehicles processing means by reprogramming it over the air to make the best use of available transmission capacity.

The information relating to position is sent in polar coordinates relative to a fixed point together with a token (i.e. identifier) indicating the name of the fixed point, for maximum bandwidth efficiency, although this is not essential. One possible structure for the contents of a message transmitted from the bus to the central unit is described below with reference to FIG. 2. Each message in this example is made up of five components named “A” to “E” for convenience. The first component A identifies one of the fixed points which is the coordinate origin used to give the bus's position in the rest of the message. This component is 8 bits long thus allowing for up to 256 possible fixed points. Component B is 16 bits long and can therefore give the radial distance of the bus from a fixed point up to 64 km +/−1 m or to a greater precision at a shorter distance. C is 12 bits long and gives the bus's bearing from a given direction (e.g. north) from the fixed point to a precision of approximately 0.1 degrees. Component D indicates the speed of the bus up to 128 meters per second to a precision of 0.5 meters per second and E indicates the direction in which it is travelling, to a precision of 6 degrees. The total length of data is 50 bits.

Alternatively the position could be given in a different coordinate system, e.g. based on latitude and longitude. 16 bit northings and eastings would give a position precision of 16 meters.

In accordance with the preferred embodiment described above, it is only necessary for a bus to send frequent position information to the fleet operator when it is travelling in a particular direction in the vicinity of a fixed way point (e.g. a bus stop). This represents a considerable reduction in transmission traffic compared with the need to interrogate every vehicle in the fleet at intervals of say less than 10 seconds.

An example of the improvement in bandwidth possible with a system in accordance with the invention is given by considering fleet of 200 vehicles which use a single radio channel to inform a base station of their respective positions. Each vehicle may travel at speeds up to 100 km per hour, but at any given time 90% of vehicles are remote from any fixed points and have an average speed of 50 Km/h, whereas the other 10% are travelling in a particular defined direction or directions within range of a fixed point and have an average speed of 30 Km/h. It is assumed that including addressing information and redundancy for protection against channel errors, each position update message has a length of 300 bits. It is also assumed that the positions of the vehicles need to be known to within 10 m for those travelling in the particular directions close to fixed points, but only to within 200 m for those out of range of a fixed point.

To achieve this with the known, fixed time or spatial frequency update systems, would require each of the 200 vehicles to send a position update once every 1.2 s (assuming a speed of 30 Km/h) to give the necessary accuracy for the 10% of vehicles travelling in the particular directions near fixed points. This would require an uplink channel capacity of (1.2)⁻¹×200×300=50 Kbs (Kilobits per second). Of course, this would only provide the required accuracy as an average, if any of the vehicles near to the fixed points were to travel faster than 30 Km/h then the accuracy would be correspondingly decreased below that specified.

By contrast, a system in accordance with the invention allows the 90% of the vehicles which are far from any of the pre-defined fixed points to give their position only every 200 m. At the assumed average speed of 50 Km/h, this requires each vehicle to send a signal every 14.4 s which requires a channel capacity of (14.4)^{31 1}×0.9×200×300=3.75 Kbs. The 10% of vehicles which are travelling in the particular directions close to one or more of the fixed points must give their positions every 10 m, which at 30 Km/h would require each to send a signal every 1.2 s (as above). The extra capacity required for this is (1.2)^{31 1}×0.1×200×300=5 Kbs. Thus the total capacity required is 8.75 Kbs rather than 50 Kbs for a comparable known system—a saving of 82.5%.

A system for monitoring a vehicle should it deviate from a predetermined route will now be described with reference to FIG. 3.

As in the previously described embodiment, the position determining means 2 makes automatically regular measurements of the vehicle's location, possibly by the observation of satellites or radio beacons. It sends the latest position to the computing equipment 4 sufficiently frequently to ensure that the vehicle can never move more than the minimum distance required by the fleet operator before the detection of a route deviation can occur, either automatically, or under direct control of the computing equipment 4.

The computing equipment 4 contains a record of the positions of series of fixed points on the vehicle's planned route. For each pair of fixed way points, the following information is stored:

a) Corridor width

b) corridor entry time

c) Corridor exit time

The corridor width represents the distance away from the line joining the two respective fixed points that the vehicle is allowed to deviate, i.e. it is the width of a linear or rectangular corridor which encompasses the actual route of the vehicle between the two way points. If the route is straight, the corridor width can he small. If the route is crooked, a greater corridor width may be required. FIG. 3 shows an example of a set of corridors 8 connecting points P₁ to P₄ via fixed points P₂ and P₃.

As the vehicle moves, the computing equipment 4 continuously obtains its position from the position determining means 2. At regular intervals it then first automatically determines the closest corridor 8 by finding the nearest pair of fixed points which appear in the route table as the start and end of a corridor 8. It then calculates the vehicle's distance from the centre line of the corridor 8 (the line joining the two fixed points). If the distance is greater than halt the stored corridor width, if the current time is later than the stored exit time, or if the current time is earlier than the stored entry time, a route deviation message is immediately transmitted automatically to the fleet controller. This message contains the vehicle's identification, measured location and velocity, and current time. It may also contain a synopsis of historical position information since the vehicle entered the previous corridor to give the operator a picture of its movements.

Table 2 gives an example of how the table of fixed point information may be stored in the vehicle's computing equipment 4. The table gives the fixed point's name, a reference number, and coordinates, here in Cartesian format, relative to some local coordinate system such as the UK's Ordnance Survey National Grid. Alternative national systems could be used, or latitudes and longitudes.

| Way point name | Way point No. | Grid Square | Easting | Northing |
|---|---|---|---|---|
| Cambridge | 1 | TL | 972 | 103 |
| St Neots | 2 | TL | 653 | 253 |
| Bedford | 3 | TK | 728 | 265 |
| Oxford | 4 | SJ | 934 | 774 |
| Milton Keynes | 5 | SK | 105 | 264 |
| Northampton | 6 | TK | 254 | 304 |
| Warwick | 7 | TL | 299 | 320 |
| Daventry | 8 | TJ | 455 | 153 |
| Caxton Gibbett | 9 | TL | 828 | 198 |

Table 3 defines the route to be taken by the vehicle by listing the corridors, in sequence.

TABLE 3

| Corridor | Entry | Exit | Corridor | Entry | Exit |
|---|---|---|---|---|---|
| No. | Way point | Way point | width | time | time |
| 1 | 1 | 9 | 2 | 10:00 | 10:30 |
| 2 | 9 | 2 | 2 | 10:15 | 10:45 |
| 3 | 2 | 3 | 4 | 10:30 | 11:00 |
| 4 | 3 | 6 | 5 | 10:45 | 11:45 |
| 5 | 6 | 8 | 4 | 11:30 | 12:00 |
| 6 | 8 | 7 | 4 | 11:45 | 13:00 |

More complex examples are possible, including for example, the day of the week.

By reference to Tables 1 and 2 the vehicle's defined route may be seen as front Cambridge to Warwick via Caxton Gibbett, St Neots, Bedford, Northampton and Daventry. It is expected to pass St Neots sometime between 10:15 and 10:30, and should arrive at Warwick no later than 13:00. The road from Cambridge to St Neots is quite straight, and the corridor width is therefore given as 2 km. The road from Bedford to Northampton is rather twisty, so the greater corridor width of 5 km is given, to ensure that the corridor is wide enough to cover the expected excursions of the vehicle along this section of the journey. Clearly, the narrower the corridor width and time windows are made, the more sensitive the system can be made to any unexpected deviations from the route.

As the vehicle progresses along its journey, the computing equipment 4 determines the two nearest fixed points by calculation of the distance of all the stored fixed points. In practice, the search can be simplified by examining the distances found during a previous calculation, and only recalculating the distances to the nearest of those—a full calculation is then only necessary on rare occasions.

If, for example, the vehicle happened to be passing through Eltisley, the computing equipment 4 would determine that fixed points 2 and 9 were the nearest, placing it nearest to corridor 2. The equipment 4 would then calculated that the vehicle was less than 1 km away from the line joining fixed points 2 and 9. Provided the time was in the range 10:15-10:45, it would conclude that the vehicle was not deviating from its intended route. If however, the vehicle had turned North at Caxton Gibbett, towards Godmanchester, its distance from the centre line of corridor 2 would exceed 1 km within one or two minutes, and the computing equipment 4 would immediately cause the ratio transmitter 6 to transmit an alerting message to fleet controller. This message might also include historical positions and times illustrating its journey since it entered the previous corridor. These data could indicate if the vehicle had stopped, for example, before it started deviating from its expected route.

Near the fixed points, there may be a problem of excessive sensitivity to minor deviations from the route. In FIG. 3, point x is very close to fixed point P₁, and yet is outside any of the route corridors 8. This can be accounted for by additionally permitting movement within a circular zone 10, around each fixed point. This circle 10 can, for example, have a radius equal to the narrowest of the corridors 8 attached to the fixed point.

As a further refinement, reverse travel through a corridor for more than a defined distance could be interpreted as a route deviation. The defined distance could be set equal to the corridor's width, or could be the subject of an additional entry for each corridor in the route table. Detection of reverse travel could be achieved by the position determining means determining the distance of the vehicle from the entry way point each time it performs a deviation calculation, and comparing this with the minimum distance it has observed for that way point since it entered the corridor.

Once a deviation has been detected, the computing equipment 4 is configured to send further position updates at regular distance and/or time intervals to assist recovery of the vehicle. Additionally or alternatively, the position updates can be sent on request from the fleet controller.

To facilitate the use of this system, it is envisaged that both the way point positions from the data may be loaded into the computer equipment 4 via radio messages. For security purposes, such radio messages should include a cryptographic authentication check. The data can also be encrypted for security purposes, if desired. As a further refinement of this arrangement, if the vehicle driver wishes to alter the route or add a new route, the proposed route is preferably first sent back to the fleet controller in a radio message. If the fleet controller approves the change it can then be sent to the vehicle as a further radio message. This reduces the opportunity for malicious alteration of the route data.

1. A method of monitoring the position of a mobile unit, comprising the steps of said mobile unit determining its position, determining its direction of travel, and transmitting information relating to its position to a central unit at intervals, wherein the interval between successive position transmissions is selected in accordance with the direction of travel of the mobile unit.

2. A method as claimed in claim 1 wherein the interval between successive position transmissions is selected in accordance with the average direction of travel over a particular time or distance.

3. A method as claimed in claim 1 or 2 wherein said direction of travel is determined at regular intervals.

4. A method as claimed in any one of the preceding claims wherein the position transmission interval selection is made from a set of two or more predetermined position update intervals on the basis of one or more predetermined selection criteria or rules.

5. A method as claimed in claim 4 comprising comparing the actual direction of travel with a direction specified in a rule and using the comparison and said rule to determine the update interval.

6. A method as claimed in any one of the preceding claims comprising selecting a default update interval until the mobile unit moves in a given direction in which case a new interval is selected.

7. A method as claimed in claim 6 comprising selecting said new interval only if the mobile unit is within a predetermined distance from a fixed point.

8. A method of monitoring the position of a mobile unit, comprising:
defining two or more predetermined locations;
defining a set of two or more predetermined position update intervals, each interval in the set being associated with one or more predetermined selection criteria each relating to the distance of the mobile unit from, or the direction of travel of the mobile unit relative to, one of the predetermined locations;
selecting an update interval from the set of predetermined update intervals on the basis of the predetermined selection criteria;
determining the position of the mobile unit; and
providing to a central unit updates of the mobile unit's position at the selected predetermined interval.

9. A method as claimed in any one of claims 6, 7 or 8 comprising setting the update interval at a first, higher value whilst the mobile unit moves along a predetermined route, and setting the update interval at a second, lower value if the mobile unit departs from said route.

10. A method of selectively monitoring the position of a mobile unit, comprising:
the mobile unit determining its position, comparing the position determined with the position of a predetermined line, and when the determined position first exceeds a predetermined distance from said predetermined line, transmitting information relating to that event to a central unit.

11. A method as claimed in claim 10 comprising transmitting position information automatically at regular intervals to said central unit when the determined position has exceeded the predetermined distance from the predetermined line.

12. A method as claimed in one of claims 9, 10 or 11 wherein said predetermined distance is constant for a given predetermined route or line.

13. A method as claimed in any one of claims 10 to 12 wherein said predetermined line is defined as the line between two fixed points on a route, said mobile unit determining which two fixed points on said route it is closest to.

14. A method of monitoring the position of a mobile unit comprising;
defining a corridor joining two predetermined points along which the mobile unit is intended to travel;
the mobile unit determining automatically whether it has left the defined corridor, and providing automatically information relating to that event to a central unit when the mobile unit determines that it has left the defined corridor.

15. A method as claimed in claim 13 or 14 comprising defining a second predetermined distance around each of said predetermined or fixed points, and said mobile unit transmitting position information if it determines that it is greater than said second predetermined distance from the predetermined or fixed point to which it is closest.

16. A method as claimed in any one of claims 10 to 15 wherein said predetermined distance or the width of said corridor is greater than the maximum distance from said predetermined line of a physical route defined for said mobile unit.

17. A method as claimed in any one of claims 10 to 16 comprising transmitting information from said mobile unit if the mobile unit is not within a given portion of an intended route at a given time or during a given time window.

18. A method as claimed in any one of claims 10 to 17 comprising transmitting information from said mobile unit if it is found to be moving in the wrong direction relative to its intended route.

19. A method as claimed in any one of claims 10 to 18 comprising transmitting signals from the mobile unit indicating correct operation in the absence of any other transmission as defined in any one of claims 10 to 18.

20. A method as claimed in any one of claims 10 to 19 comprising storing within the mobile unit information related to the predetermined time or corridor and the associated predetermined distance or distances.

21. A method as claimed in any one of the preceding claims comprising transmitting position update information from the mobile unit to a or the central unit at regular spatial intervals.

22. A method as claimed in claim 21 comprising determining said updates using the net displacement of the mobile unit from a given point.

23. A method as claimed in claim 21 or 22 comprising determining by how much the position of the apparatus or mobile unit has changed by comparing a determined position with a previously determined position.

24. A method as claimed in claim 21, 22 or 23 comprising transmitting said update information additionally at specified temporal intervals.

25. A method as claimed in any one of the preceding claims comprising determining the absolute position of said mobile unit.

26. A method as claimed in any one of the preceding claims comprising determining the position of the mobile unit at sufficiently regular intervals that the mobile unit will not move more than a predetermined minimum aspatial resolution between determinations.

27. A method as claimed in any one of the preceding claims comprising transmitting from the mobile unit to a or the central unit information relating to the velocity of the mobile unit.

28. A method as claimed in any preceding claim comprising monitoring the position of a plurality of mobile units.

29. A position updating apparatus, comprising:
means for determining the position of the apparatus;
means for determining the direction of travel of the apparatus;
means for transmitting information relating to the position of the apparatus to a central unit at selected intervals; and
means for selecting the interval between successive position information transmissions on the basis of the direction of travel of the mobile unit.

30. An apparatus for monitoring the position of a mobile unit, comprising:
means for determining the position of the mobile unit;
means for storing the positions of two or more predetermined locations; means for storing a set of two or more predetermined position update intervals, each interval in the set being associated with one or more predetermined selection criteria each relating to the distance of the mobile unit from, or the direction of travel of the mobile unit relative to, one of the predetermined locations; and
means for providing to a central unit updates of the mobile unit's position at intervals selected from the set of predetermined update intervals on the basis of the predetermined selection criteria.

31. An apparatus for selectively monitoring the position of a mobile unit, comprising:
means for determining the position of the mobile unit;
means for comparing the position determined with the position of a predetermined line; and
means for when the determined position first exceeds a predetermined distance from said predetermined line, transmitting information relating to that event to a central unit.

32. An apparatus for monitoring the position of a mobile unit, comprising:
means for storing the definition of a predetermined corridor joining two predetermined points along which the mobile unit is intended to travel;
means for determining whether the mobile unit has left the defined corridor, and providing information relating to that event to a central unit when it is determined that the mobile unit has left the defined corridor.

33. An apparatus as claimed in any one of claims 30 to 32 comprising a memory which stores a plurality of predetermined update intervals and one or more rules for determining the interval to be used, and means for selecting the update interval in accordance with those rules.

34. An apparatus as claimed in any one of claims 29 to 33 comprising means to determine the absolute position of the apparatus.

35. Computer software specifically adapted to carry out the method of any one of claims 1 to 28 when installed on data processing means.

36. A computer software carrier comprising software as claimed in claim 35, which, when used to control one or more digital computers within a position updating apparatus, causes said apparatus to carry out said method.

37. A method of monitoring the position of a mobile unit substantially as hereinbefore described with reference to the accompanying drawings.

38. An apparatus for monitoring the position of a mobile unit substantially as hereinbefore described with reference to the accompanying drawings.
